(19) United States
(12) Patent Application Publication
(10) Pub. No.: US 2006/0005133 A1
(43) Pub. Date: Jan. 5, 2006

(54) Graphical representation of the availability of an instant messaging user for communication

(75) Inventors: Ruthie D. Lyle, Durham, NC (US); Veronique Moses, Raleigh, NC (US); Fonda J. Daniels, Cary, NC (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: International Business Machines Corporation, Armonk, NY (US)

(21) Appl. No.: 10/881,842

(22) Filed: Jun. 30, 2004

(51) Int. Cl. G06F 3/00; G06F 15/16

(52) U.S. Cl. 715/708; 715/752; 715/753; 715/758; 709/204; 709/206

(57) ABSTRACT

Described is a method for indicating a communication availability of a first instant messaging user to a second instant messaging user. An icon is displayed on a user interface of the second instant messaging user to indicate at least one of a user state and a user location of the first instant messaging user. A graphical parameter of the displayed icon is set to one of a plurality of states in response to the communication availability of the first instant messaging user. The communication availability is determined according to a communication policy dependent on the user state and the user location of the first instant messaging user.

### FIELD OF THE INVENTION

The invention relates generally to instant messaging systems. In particular, the invention relates to a method to provide an instant messaging user with a graphical representation of the state, location and communication availability of another instant messaging user.

### BACKGROUND OF THE INVENTION

Instant messaging (IM) is a service that allows a group of people to communicate efficiently with one another in real time through defined communication channels. Typically an IM user maintains a list of other IM users with whom the M user frequently communicates. For example, one type of list referred to as a “buddy list” includes the names or identifiers for list members that may include co-workers, friends, relatives and other acquaintances of the M user. The IM service alerts the IM user to the availability of members for communication through a graphical representation in the buddy list. For example, when a list member becomes available for online communication, the IM user can receive an audible alert and a presence indicator in the buddy list changes to indicate that the list member is available for communication.

In some instances, the nature of an instant message stimulates the need for follow up communication in forms other than IM. A “face to face” conversation or a telephone call may be preferred. In addition, the availability of IM users can change over time so that one IM user may wish to immediately converse with a second IM user who may no longer be available. In this instance the second IM user can be engaged in an important phone call or can be required to attend a business meeting and may wish not to be interrupted. Alternatively, the second IM user may be actively engaged in a telephone conversation or business meeting, but may welcome an interruption by telephone or in person to handle an urgent matter with the first IM user. Unfortunately, current IM systems provide a user interface that does not permit an IM user to know the state (i.e., whether the IM user is in a meeting, engaged in a telephone call, etc.) and the physical location (e.g., whether the IM user is in their office, at home, or on travel by train or aircraft) of another IM user. Consequently, an IM user may be discouraged or prohibited from communicating with the other IM user if the other IM user is not designated as online and therefore available for immediate communication.

What is needed is a method for alerting an IM user with the state and location of another IM user to facilitate subsequent communication between the IM users. The present invention satisfies this need and provides additional advantages.

### SUMMARY OF THE INVENTION

In one aspect, the invention features a method for indicating a communication availability of a first instant messaging user to a second instant messaging user. One of a plurality of icons is displayed on a user interface of the second instant messenger. Each of the icons indicates at least one of a user state and a user location of an instant messaging user. The displayed icon is determined in response to at least one of the user state and the user location of the first instant messaging user. A graphical parameter of the displayed icon is set in one of a plurality of states in response to the communication availability of the first instant messaging user. The communication availability is determined according to a communication policy dependent on the user state and the user location of the first instant messaging user.

In another aspect, the invention features a computer program product for indicating the communication availability of a first instant messaging user to a second instant messaging user. The computer program product includes a computer useable medium having embodied therein program code for displaying one of a plurality of icons on a user interface of the second instant messaging user and program code for setting a graphical parameter of the displayed icon in one of a plurality of states in response to the communication availability of the first instant messaging user. Each icon indicates at least one of a user state and a user location of an instant messaging user. The displayed icon is determined in response to at least one of the user state and the user location of the first instant messaging user. The communication availability is determined according to a communication policy dependent on the user state and the user location of the first instant messaging user.

In still another aspect, the invention features a computer data signal embodied in a carrier wave for indicating the communication availability of a first instant messaging user to a second instant messaging user. The computer data signal includes program code for displaying one of a plurality of icons on a user interface of the second instant messaging user and program code for setting a graphical parameter of the displayed icon in one of a plurality of states in response to the communication availability of the first instant messaging user. Each icon indicates at least one of a user state and a user location of an instant messaging user. The displayed icon is determined in response to at least one of the user state and the user location of the first instant messaging user. The communication availability is determined according to a communication policy dependent on the user state and the user location of the first instant messaging user.

In yet another aspect, the invention features an apparatus for indicating a communication availability of a first instant messaging user to a second instant messaging user. The apparatus includes means for displaying one of a plurality of icons on a user interface of the second instant messaging user and means for setting a graphical parameter of the displayed icon in one of a plurality of states in response to the communication availability of the first instant messaging user. Each icon indicates at least one of a user state and a user location of an instant messaging user. The displayed icon is determined in response to at least one of the user state and the user location of the first instant messaging user. The communication availability is determined according to a communication policy dependent on the user state and the user location of the first instant messaging user.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is an illustration of a networked environment for instant messaging clients.

FIG. 2A through FIG. 2F show icons for display on the user interface of an instant messaging client device in accordance with an embodiment of the invention.

FIG. 3 illustrates the icon of FIG. 2A on a colored background to indicate the availability of an instant messaging user in accordance with an embodiment of a method for indicating communication availability according to the invention.

FIG. 4 is a flowchart representation of an embodiment of a method for indicating a communication availability of an instant messaging user to another instant messaging client in accordance with the invention.

### DETAILED DESCRIPTION

In brief overview the present invention relates to a method for indicating a communication availability of a first instant messaging (IM) user to a second IM user. An icon is displayed on a user interface of the second IM user to indicate at least one of a user state and a user location (i.e., where the user is physically present) for the first IM user. Different icons are available to represent various user states and user locations. A graphical parameter of the displayed icon is set to one of many defined states according to the availability of the first IM user for communication by IM and alternative forms of communication. The first IM user's communication availability is determined from a communication policy which describes the preferred communication modes for different user states and user locations.

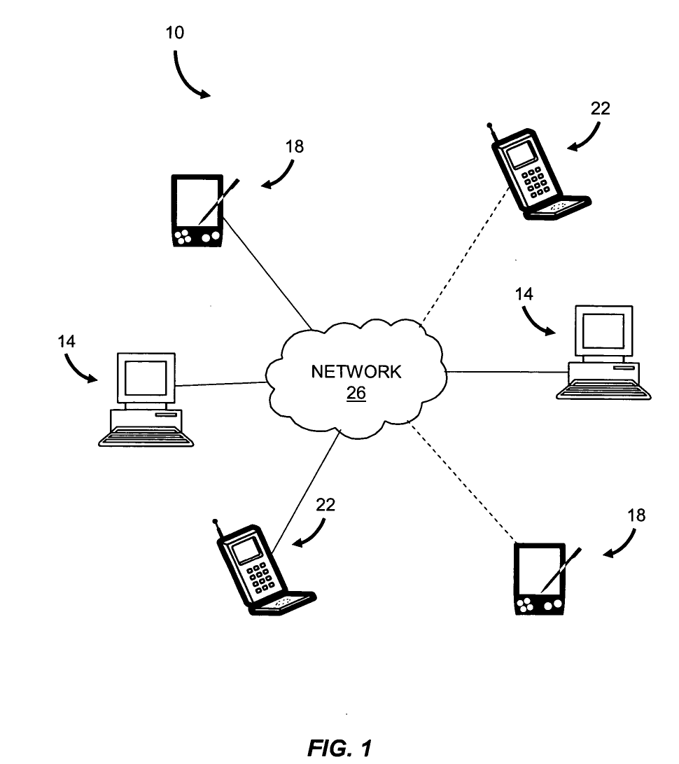

FIG. 1 illustrates a networked environment 10 in which various IM client devices communicate with each other. As illustrated, the IM client devices include personal computers (PCs) 14, personal digital assistants (PDAs) 18, and IM enabled cell phones 22 communicating over a network 26. Other devices capable of transmitting and receiving IM communications are also contemplated as IM client devices. The network 26 can be an intranet, the Internet or any network or combination of networks that supports the transmission of IM data between the client devices. Each client device includes a user interface for the presentation of text and graphics to an IM user.

The ability of an IM user to communicate rapidly with another IM user is generally limited to the time during which both IM users are online. If one IM user goes offline, another IM user cannot immediately communicate with the offline IM user. In a business environment, the availability to communicate with other employees is often of paramount importance. For example, a business situation can arise in which an employee may seek quick advice from a knowledgeable employee. Similarly, an employee can require permission from a supervisor to perform a particular task. If the knowledgeable employee or supervisor is not available in the IM session, the employee seeking the response may have to make numerous telephone calls to various locations to find the employee or supervisor. Moreover, employees working with the supervisor may shield the supervisor from interruptions if the supervisor is engaged in a meeting or a telephone call. In some instances, the knowledgeable employee or supervisor may be willing to receive interruptions despite being in a meeting or on the telephone. Unfortunately, the seeking employee can expend significant time and effort to track down the other employee or supervisor without any guarantee of success.

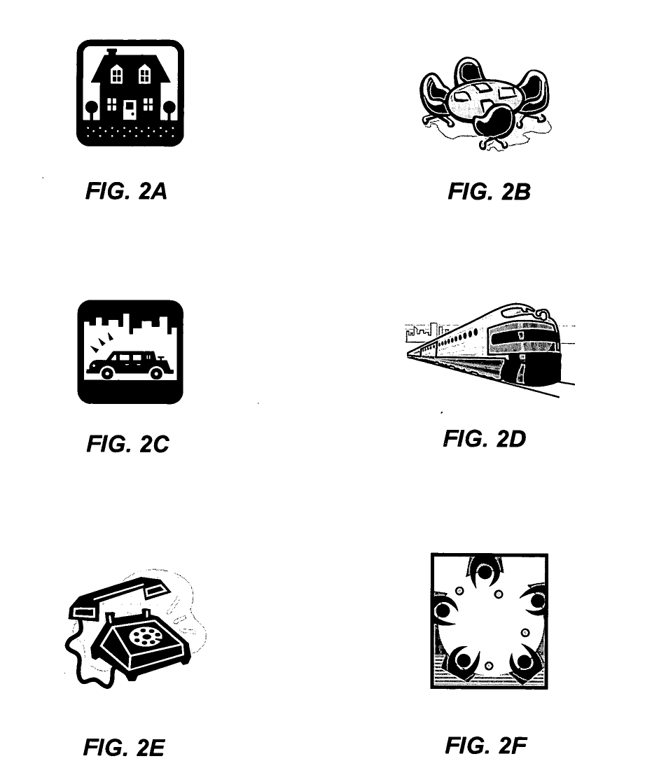

The method of the present invention allows an IM user to quickly determine the communication availability of another IM user by viewing an icon displayed on a user interface of an IM client device. The icon indicates the user state, user location, or combination of user state and user location of the other IM user. FIGS. 2A through 2F illustrate examples of icons that can be used to convey the user state and user location information to an IM user. FIGS. 2A through 2D indicate that the IM user is located at home, in a conference room, traveling by car, or traveling by train, respectively. FIGS. 2E and 2F show icons indicating user states for an IM user engaged in a telephone conversation or participating in a meeting, respectively. Icons can be combined to convey user state and user location information. For example, a combined icon can be generated which shows the house of FIG. 2A and the telephone of FIG. 2E to indicate that the IM user is currently at home and is engaged in a telephone conversation.

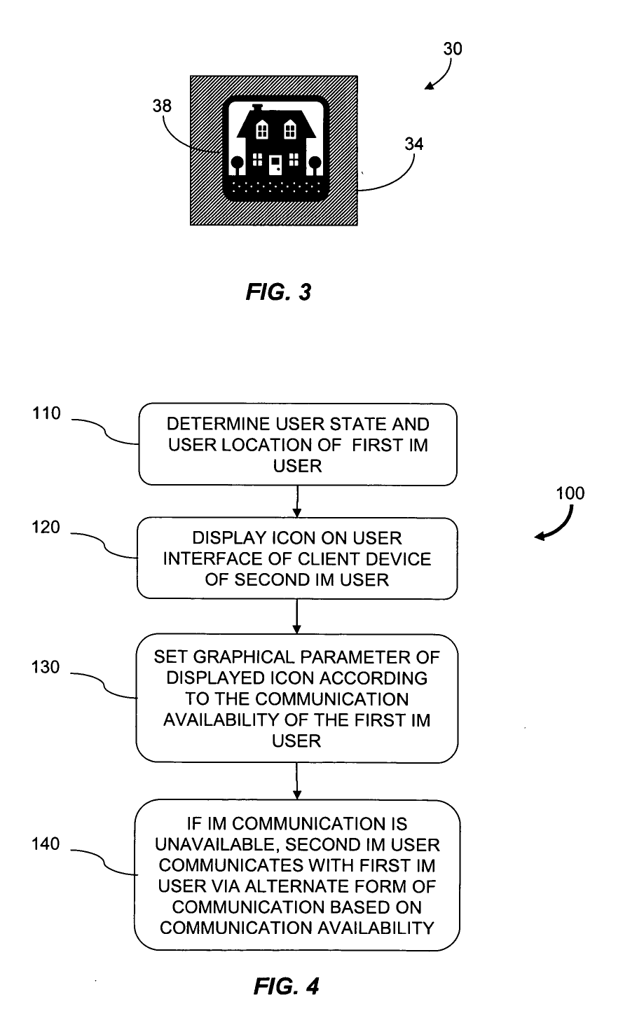

Each icon can be displayed in a particular color to indicate- the availability of the IM user for communication. For example, red, green, yellow and orange can be used to indicate that the IM user is not available, is available, has limited availability and is available by one or more other communication mechanisms (e.g., email). Limited availability may indicate that the IM user is away on business travel or vacation, but is available for urgent communications. FIG. 3 illustrates an embodiment in which an icon 30 is unchanged regardless of the communication availability of the IM user. A background region 34 has a color that changes to indicate the IM user's communication availability based on the current user state and the current user location while the color of the image portion 38 of the icon 30 remains unchanged.

In other embodiments one or more other graphical parameters of the displayed icon 30 are changed. For example, the color of the image portion 38 can change to indicate different communication availabilities. In another example, the color of lines outlining the icon 30 is changed. Optionally, the icon 30 can be in one of many animation modes depending on the current communication availability of the IM user. For example, the icon 30 can present a “moving” image depicting a person talking on a telephone. The IM user viewing the icon 30 would recognize that the other IM user cannot readily accept a follow up telephone call and may not be able to respond quickly to IM messages.

A flowchart representation of an embodiment of a method 100 for indicating a communication availability of an instant messaging user to another instant messaging client according to the invention is shown in FIG. 4. The user state and user location of a first IM user are determined (step 110) using one or more techniques. The user state and user location can information entered directly through the user interface of an IM client device. Alternatively, the information can be retrieved from an existing database or provided by a presence mechanism as described below. An icon is displayed (step 120) on a user interface of the IM client device of a second IM user seeking to communicate with the first IM user. The icon is selected from a group of icons in which each icon indicates the user state, the user location, or the user state and user location of the first IM user. A graphical parameter of the displayed icon is set (step 130) to one of multiple possible states according to a communication availability of the first IM user. As examples, the icon color, the icon background color or an animation mode of an animated icon are changed in response to a change in the communication availability. The communication availability is determined according to a communication policy defined by the first IM user for various user states and user locations. Based on the displayed information, the second IM user elects to communicate (step 140) with the first IM user by an alternative form of communication according to the communication availability if IM communication is not possible.

The IM user can enter the user state and user location information manually. For example, the IM user can select a button or icon from a user interface on the IM client device. The information can be changed by the IM user real time, or may expire after a fixed time such as an eight hour period. Alternatively, the user state or user location can be automatically updated for the IM user according to a timekeeping database. The timekeeping database resides on the client device or is otherwise accessible to the client device through a communication network. Timekeeping databases can include data shared with scheduling and calendar applications utilized by the IM user. For example, information describing the time and location of a meeting is used to establish the user state and user location for the IM user for the duration of the meeting.

One or both of the user state and user location of the IM user can be determined automatically by a presence mechanism. As used herein, a presence mechanism is any system that identifies the user location or the user state of an IM user interacting with the system. In an example of such a system, a computer network management system is interrogated to determine the user location of the IM user. If the IM user is active at a network device in the associated computer network, the computer network management system reports the physical location of that network device. Alternatively, a location dependent user service is queried to retrieve information defining the user location. Location dependent services include, for example, wireless networks. As an IM user travels, communications are maintained through different network nodes. Thus it is possible to know the location of the IM user to within an area served by a single wireless communications node communicating directly with the IM client device. In another example, user state information is derived through interrogation of a telephone network. In still another example, the presence of the IM user is determined from an identification (ID) device (e.g., a smart badge) carried on the person. Radio frequency (RF) based systems, optical systems and the like can determine the room or building in which the IM user is present by reading the ID device.

The communication availability of the N user can be determined according to a communication policy based on a user profile defined by the user. For example, an IM user indicates in the communication policy that communication availability should be displayed as red when the IM user is in the office and engaged in a telephone conservation, indicating that the IM user does not wish to be interrupted through any form of communication. The IM user can define other colors for communication availability for other times when the IM user is in the office and engaged in a telephone conversation, but is willing to accept other forms of communication.

While the invention has been shown and described with reference to specific embodiments, it should be understood by those skilled in the art that various changes in form and detail may be made therein without departing from the spirit and scope of the invention.

What is claimed is:

1. A method for indicating a communication availability of a first instant messaging user to a second instant messaging user, the method comprising:
displaying one of a plurality of icons on a user interface of the second instant messaging user, each of the icons indicating at least one of a user state and a user location of an instant messaging user, the displayed icon being determined in response to at least one of the user state and the user location of the first instant messaging user; and
setting a graphical parameter of the displayed icon in one of a plurality of states in response to the communication availability of the first instant messaging user, the communication availability being determined according to a communication policy dependent on the user state and the user location of the first instant messaging user.

2. The method of claim 1 wherein the graphical parameter is a color of the displayed icon.

3. The method of claim 1 wherein the graphical parameter is a background color of the displayed icon.

4. The method of claim 1 further comprising entering the user state and the user location of the first instant messaging user through a user interface of the first instant messaging user.

5. The method of claim 1 further comprising determining at least one of the user state and the user location of the first instant messaging user from a user timekeeping database.

6. The method of claim 1 further comprising determining the user state of the first instant messaging user by interrogating a presence mechanism.

7. The method of claim 1 further comprising determining the user location of the first instant messaging user by interrogating a location dependent user service.

8. A computer program product for indicating the communication availability of a first instant messaging user to a second instant messaging user, the computer program product comprising a computer useable medium having embodied therein program code comprising:
program code for displaying one of a plurality of icons on a user interface of the second instant messaging user, each of the icons indicating at least one of a user state and a user location of an instant messaging user, the displayed icon being determined in response to at least one of the user state and the user location of the first instant messaging user; and
program code for setting a graphical parameter of the displayed icon in one of a plurality of states in response to the communication availability of the first instant messaging user, the communication availability being determined according to a communication policy dependent on the user state and the user location of the first instant messaging user.

9. The computer program product of claim 8 further comprising program code for entering the user state and the user location of the first instant messaging user through a user interface of the first instant messaging user.

10. The computer program product of claim 8 further comprising program code for determining at least one of the user state and the user location of the first instant messaging user from a user timekeeping database.

11. The computer program product of claim 8 further comprising program code for determining the user state of the first instant messaging user by interrogating a presence mechanism.

12. The computer program product of claim 8 further comprising program code for determining the user location of the first instant messaging user by interrogating a location dependent user service.

13. A computer data signal embodied in a carrier wave for indicating the communication availability of a first instant messaging user to a second instant messaging user, the computer data signal comprising:
program code for displaying one of a plurality of icons on a user interface of the second instant messaging user, each of the icons indicating at least one of a user state and a user location of an instant messaging user, the displayed icon being determined in response to at least one of the user state and the user location of the first instant messaging user; and
program code for setting a graphical parameter of the displayed icon in one of a plurality of states in response to the communication availability of the first instant messaging user, the communication availability being determined according to a communication policy dependent on the user state and the user location of the first instant messaging user.

14. The computer data signal of claim 13 further comprising program code for entering the user state and the user location of the first instant messaging user through a user interface of the first instant messaging user.

15. The computer data signal of claim 13 further comprising program code for determining at least one of the user state and the user location of the first instant messaging user from a user timekeeping database.

16. The computer data signal of claim 13 further comprising program code for determining the user state of the first instant messaging user by interrogating a presence mechanism.

17. The computer data signal of claim 13 further comprising program code for determining the user location of the first instant messaging user by interrogating a location dependent user service.

18. An apparatus for indicating a communication availability of a first instant messaging user to a second instant messaging user, the apparatus comprising:
means for displaying one of a plurality of icons on a user interface of the second instant messaging user, each of the icons indicating at least one of a user state and a user location of an instant messaging user, the displayed icon being determined in response to at least one of the user state and the user location of the first instant messaging user; and
means for setting a graphical parameter of the displayed icon in one of a plurality of states in response to the communication availability of the first instant messaging user, the communication availability being determined according to a communication policy dependent on the user state and the user location of the first instant messaging user.

19. The apparatus of claim 18 further comprising means for entering the user state and the user location of the first instant messaging user through a user interface of the first instant messaging user.

20. The apparatus of claim 18 further comprising means for retrieving information describing at least one of the user state and the user location of the first instant messaging user from a user timekeeping database.

21. The apparatus of claim 18 further comprising means for interrogating a presence mechanism to determine the user state of the first instant messaging user.

22. The apparatus of claim 18 further comprising means for interrogating a location dependent user service to determine the user location of the first instant messaging user.
